(19) United States
(12) Patent Application Publication
(10) Pub. No.: US 2013/0261875 A1
(43) Pub. Date: Oct. 3, 2013

(54) Control Module for a Vehicle System, the Vehicle System and a Vehicle Having this Vehicle System

(71) Applicant: Waldemar Kamischke, Neustadt (DE)

(72) Inventor: Waldemar Kamischke, Neustadt (DE)

(73) Assignee: WABCO GmbH, Hannover (DE)

(21) Appl. No.: 13/883,333

(22) PCT Filed: Aug. 17, 2011
(86) PCT No.: PCT/EP2011/004139

§ 371 Date: May 3, 2013

(30) Foreign Application Priority Data
Nov. 5, 2010 (DE) 102010050635.4

(51) Int. Cl. G01P 15/00

(52) U.S. Cl. CPC G01P 15/00
USPC 701/29.1

(57) ABSTRACT

A control module for a vehicle system has: a lateral acceleration sensor for measuring a lateral acceleration and outputting a lateral acceleration measurement signal, a yaw rate sensor for detecting a yaw rate and outputting a yaw rate measurement signal, and a central control device for receiving the yaw rate measurement signal and the lateral acceleration measurement signal and determining a lateral acceleration of the vehicle at its center-of-gravity. The central control device determines the center-of-gravity lateral acceleration from a sensor distance of the lateral acceleration sensor from the vehicle center-of-gravity and the yaw rate measurement signal, forming a derivative over time. The central control device filters the yaw rate measurement signal with a low-pass filter and subsequently forms a derivative over time and determines the sensor distance on an up-to-date basis.

### FIELD OF THE INVENTION

The present invention generally relates to a control module and method for controlling or regulating a vehicle system.

### BACKGROUND OF THE INVENTION

Vehicle dynamics control systems enable vehicle instabilities to be identified and corrected. In particular, rolling tendencies of the vehicle and oversteer or understeer tendencies may be determined. The vehicle stability systems sometimes have lateral acceleration sensors and yaw rate sensors for this purpose. With the aid of the determined yaw rate of the vehicle, i.e., the rotational frequency around the vertical axis of the vehicle, and the lateral acceleration in the lateral direction as well as the known vehicle velocity, vehicle stability can be improved by targeted wheel brake interventions or corrective behavior can be indicated for the driver.

In general, a control module, to which a central control unit and, e.g., the yaw rate sensor and lateral acceleration sensor are attached, is used for the vehicle dynamics control system or vehicle stability control system. The installation location is in general the center of gravity of the vehicle, since the relevant vehicle dynamics variables can be directly measured there. DE 198 56 303 A, DE 10 2005 033 237 B4, DE 10 2005 059 229 A1, and EP 1351843 B1 describe corresponding sensor systems and vehicle dynamics control systems.

In some vehicles, however, placement of the sensor module in the vehicle center of gravity or very close to the vehicle center of gravity is not possible. Thus, e.g., in tour buses, the vehicle center of gravity can be in or about the passenger compartment or occupied by other vehicle components. The yaw rate of a vehicle is generally equal in all points of the vehicle and therefore can also be determined by means of a sensor outside the center of gravity; however, the measurement of the vehicle lateral acceleration outside the center of gravity results in incorrect values, since contributions arise through the dynamic rotation of the vehicle, i.e., the yaw rate.

US 20070106444 A1 describes a system in which the lateral acceleration is measured by means of a sensor outside the vehicle center of gravity. Subsequently, the lateral acceleration in the vehicle center of gravity is determined from this measured lateral acceleration, a yaw rate change, and the lever arm, which is formed as the sensor distance between the center of gravity and the sensor installation location. For this purpose, the yaw rate change is determined from two successive measuring signals of the yaw rate sensor. The sensor distance of the lateral acceleration sensor in relation to the vehicle center of gravity is assumed to be given.

However, such a measuring system is subject to the disadvantage that because of the signal noise during successive measured values, a yaw rate change thus determined can be relatively large, and in combination with incorrect specifications of the sensor distance of the lateral acceleration sensor in relation to the center of gravity, compensation values may occur, which are greater than the lateral acceleration measuring signal. A vehicle lateral acceleration of the vehicle center of gravity thus determined is therefore generally not sufficiently precise for vehicle control systems.

### SUMMARY OF THE INVENTION

Generally speaking, it is an object of the present invention to provide a sensor module for a vehicle system and a method for controlling or regulating a vehicle, that enable sufficiently precise determination of the vehicle lateral acceleration even when at least the lateral acceleration sensor is installed outside the vehicle's center of gravity.

According to embodiments of the present invention, calculating the vehicle lateral acceleration in the vehicle center of gravity while measuring the vehicle lateral acceleration outside the center of gravity is salutary if appropriate corrections are performed in the case of some of the employed variables. A light low-pass filtering of the yaw rate measuring signal even before the formation of a time derivative is advantageous. In particular, a Tschebyscheff filter is quite suitable for performing low-pass filtering before the formation of the time derivative. The use of a limiting frequency in the range of about 7 to 10 Hz, in particular, about 7.5 to 8.5 Hz is advantageous in this case.

In accordance with embodiments of the present invention, through the use of a Tschebyscheff filter (which is not excessively complex with regard to computation) for the recorded yaw rate measuring signals, a significant improvement of the correction or compensation, i.e., of the determination of the vehicle lateral acceleration in the vehicle center of gravity, is possible. A particular advantage of the Tschebyscheff filter is its flank steepness. The filtering by the Tschebyscheff filter should be sufficiently low to eliminate noise; however, an excessively low limiting frequency could cause the correction of the lateral acceleration to occur excessively slowly in the event of a rapid change of the yaw rate and thus cause overshoots to arise on the corrected signals, i.e., the dynamic response or consideration of the time change of the yaw rate could become excessively small, in order to be able to operate a safety-relevant vehicle control system in this way.

According to embodiments of the present invention, using a Tschebyscheff filter and simultaneously incorporating calculated values of the sensor distance is particularly advantageous. In the event of incorrect sensor distance values in the formula for determining the vehicle lateral acceleration from the yaw rate change and the distance, use of a Tschebyscheff filter can rapidly result in incorrect values, which can be greater than with other low-pass filters.

An instantaneous determination of the sensor distance can be performed in this case in particular by determining the vehicle center of gravity. Determining the vehicle center of gravity is possible in the vehicle X direction by applying a torque equilibrium, in which the wheel loads or axle loads, i.e., weight distributions acting on the wheel axles in the vehicle longitudinal direction, are used, or the vehicle is divided into modules and the effect of the module weights on the wheel axles is determined.

Therefore, through these two calculations, on the one hand, the Tschebyscheff filtering before determining the yaw rate change and, on the other hand, the determination of the vehicle center of gravity relative to the lateral acceleration sensor, precise determination of the vehicle lateral acceleration in the vehicle center of gravity is possible.

Still other objects and advantages of the present invention will in part be obvious and will in part be apparent from the specification.

The present invention accordingly comprises the several steps and the relation of one or more of such steps with respect to each of the others, and embodies features of construction, combinations of elements, and arrangement of parts adapted to effect such steps, all as exemplified in the detailed disclosure hereinafter set forth, and the scope of the invention will be indicated in the claims.

### BRIEF DESCRIPTION OF THE DRAWINGS

The invention will be explained in greater detail hereafter on the basis of the appended drawings of exemplary embodiments, in which:

FIG. 1 shows a vehicle according to an embodiment of the present invention with specification of relevant distances;

FIG. 2 illustrates torque equilibrium with three bodies according to an embodiment of the present invention;

FIG. 3 illustrates the distribution and determination of different module weights in the vehicle according to an embodiment of the present invention;

FIG. 4 is a top view of a vehicle according to an embodiment of the present invention illustrating the vehicle stability control system; and

FIG. 5 is a flow chart illustrating a control method according to an embodiment of the present invention.

### LIST OF REFERENCE NUMBERS/CHARACTERS

1 utility vehicle
2 control module
3 vehicle dynamics control system
5 wheel brakes
6 central control unit
7 yaw rate sensor
8 lateral acceleration sensor
A1, A2, A3 axles
a_s sensor lateral acceleration
aq center of gravity lateral acceleration
d distance of the control module 2 from the center of gravity S
fg limiting frequency for the Tschebyscheff filter
Lges vehicle length
S center of gravity
S1 control signals
S2 yaw rate measuring signal
S3 lateral acceleration measuring signal
S4 filtered signals
St0, St1, St2, St3, St4, St5 method steps
X vehicle longitudinal direction
Y transverse direction
Z vertical direction
AB1, AB2, AB3, AB4 module masses
F1, F2, F3 wheel loads
F1, F2, F3 axle loads on axles A1, A2, A3.
L1, L2, L3 mean overhangs of modules AB1, AB2, AB3
R1, R2 wheel bases
x1, x2, x3 distance of the centers of gravity of modules AB 1, AB2, AB3 to axles
φ yaw rate
φ′ yaw rate change

### DETAILED DESCRIPTION OF THE PREFERRED EMBODIMENTS

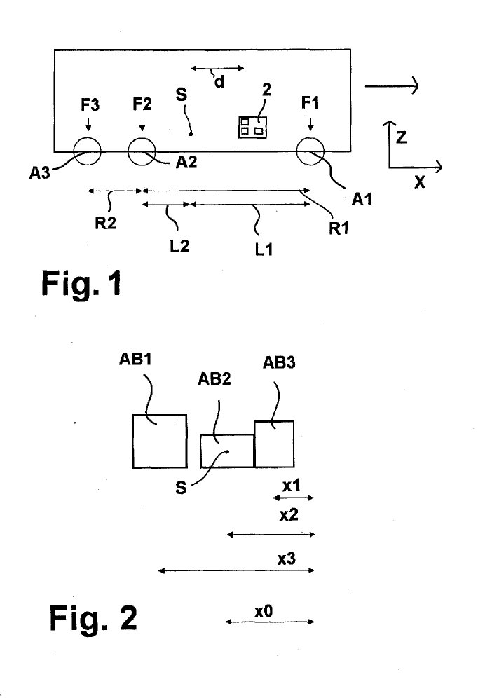

A utility vehicle 1 has three axles A1, A2, and A3, wherein A1 is the front axle. The vehicle 1 travels in the longitudinal direction or X direction. The transverse direction or Y direction and vertical direction or Z direction are shown accordingly in FIGS. 1 and 4. Furthermore, the center of gravity S of the utility vehicle 1 and a control module 2 of its vehicle dynamics control system or vehicle stability system are shown. The vehicle dynamics control system 3 acts according to the schematic illustration of FIG. 4 by means of control signals S1 on wheel brakes 5 of the vehicle on the wheels of the axles A1, A2, and A3, as is known per se.

The control module 2 has a central control unit 6, a yaw rate sensor 7 for measuring a yaw rate φ, and a lateral acceleration sensor 8 for measuring a sensor lateral acceleration a_s. The yaw rate sensor 7 outputs a yaw rate measuring signal S2 to the central control unit 6; the lateral acceleration sensor 8 accordingly outputs a lateral acceleration measuring signal S3 to the central control unit 6. The central control unit 6 also records other signals, in particular wheel speed signals of wheel speed sensors or ABS sensors (not shown) on the wheels of the axles A1, A2, and A3, as is known per se to a person skilled in the art. In the schematic illustration of FIG. 4, the control module 2 is shown significantly enlarged in this case for the detailed illustration of the sensors 7, 8 and the signals S2, S3.

The control module 2 including the sensors 7, 8 is spaced apart in the X direction by a distance d from the center of gravity S of the vehicle 1. In the center of gravity S, the center of gravity lateral acceleration aq occurs, which can in general be different from the sensor lateral acceleration a_s. The yaw rate φ, in contrast, is independent of the longitudinal position in the X direction.

The measured sensor lateral acceleration a_s is compensated or corrected in order to ascertain the center of gravity lateral acceleration aq therefrom. This is performed based on the sensor lateral acceleration a_s, the yaw rate φ, and the distance d according to the formula:

aq=φ′d+a_{—}s,

where φ′ is the yaw rate change, i.e., the time derivative dφ/dt of the yaw rate φ.

The distance d therefore represents the lever arm, with which the yaw rate change φ′ provides a contribution to the sensor lateral acceleration signal a_s.

According to an embodiment of the present invention, the distance d and the yaw rate change φ′ are therefore to be determined. The installation position of the lateral acceleration sensor 8 or of the entire control module 2 is known, wherein the sensors 7 and/or 8 can also be installed outside the control module 2. The center of gravity S or its longitudinal position is therefore to be determined. This can preferably be accomplished by:
1) determining the vehicle center of gravity S from module weights,
2) determining the vehicle center of gravity S from wheel loads on the axles A1, A2, A3 or the wheels of the axles A1, A2, A3,
3) determining the vehicle center of gravity S with the aid of external systems.

Furthermore, according to an embodiment of the invention, the yaw rate change φ′ is determined, in that the yaw rate measuring signal S2 is first subjected to low-pass filtering, and subsequently the time derivative is formed, as described hereafter.

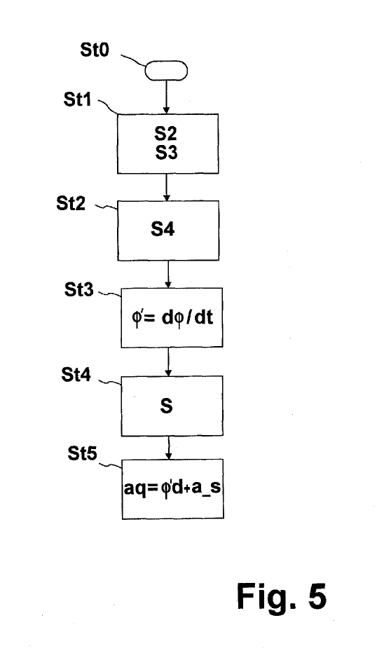

A control method according to an embodiment of the invention is illustrated in greater detail in the schematic flow chart of FIG. 5. The method starts at step St0, e.g., upon turning on the ignition of the vehicle 1. Subsequently, in step St1, measurements are carried out by the sensors 7 and 8 and the measuring signals S2 and S3 are output to the central control unit 6. In step St2, low-pass filtering of the yaw rate measuring signal S2 is subsequently performed by means of a Tschebyscheff filter, whereby filtered signals S4 are formed. The filtered signals S4 are subsequently subjected in step St3 to a time differentiation or time derivation, whereby the yaw rate change φ′ is determined. In step St4, the center of gravity S of the utility vehicle 1 and, therefrom, the distance d to the installation location of the central control unit 6 or the lateral acceleration sensor 8, respectively, is determined. In step St5, the center of gravity lateral acceleration aq is then determined as aq=φ′d+a_s using the above equation. The step St4 can fundamentally also be performed before step St2; it is relevant that the required values are present in step St5.

According to an embodiment of the invention, Tschebyscheff low-pass filtering is employed in order to filter the yaw rate measuring signals to form the time derivative. The high flank steepness is advantageous in this case of Tschebyscheff filtering.

A limiting frequency fg of about 7 to 10 Hz, preferably 7 to 9 Hz or 7.5 to 8.5 Hz, i.e., around about 8 Hz, is advantageous for the Tschebyscheff filter. Filtering using fg above 10 Hz is not recommended. The yaw rate measuring signals S2 per se are themselves still sufficient for ascertaining a yaw rate if necessary; however, they can scatter too much for the formation of a time derivative, so that a time differential formation or formation of the time derivative as a difference quotient of two successive measurements does not result in sufficient accuracy. An excessively strong low-pass filtering in turn can worsen the dynamics and response time of the vehicle control system or of the vehicle stability program.

At excessively low limiting frequencies, variations in the measuring signal are remedied again; however, a potential disadvantageous effect is that in the event of rapid change of the yaw rate, the correction of the signal and therefore also the correction of the calculated lateral acceleration occurs too slowly and, in this way, overshoots may arise on the corrected signals.

The time derivative dφ/dt can already be produced by forming a simple differential quotient, which is formed as the quotient Δφ/Δt from the difference between two successive values and the difference of the points in time of the measurements. However, a time derivative is advantageously formed while incorporating multiple measured values, i.e., as a tangent formation on the previously determined function of the filtered signal S4, since a smoother function is formed by the Tschebyscheff filtering; this subsequent derivation by tangent formation is advantageous, since it takes the curve profile as a whole into consideration.

In step St4, the vehicle center of gravity S is determined substantially instantaneously. Because of different loads and load states of the vehicle 1, previously set vehicle data may not be sufficiently precise; therefore, the respective instantaneous determination of the distance d is made possible in that the installation location of the module 2 or of the lateral acceleration sensor 8, respectively, is known and the center of gravity S is determined from current measuring signals or measuring data, optionally with incorporation of external signals or measuring signals.

The determination of the center of gravity S can be performed by different variants. According to an embodiment shown in FIG. 2, the center of gravity S of the vehicle 1 is determined from the torque equilibrium, i.e., its longitudinal position x0 results as the quotient of the sum of the torques (ABi*xi) divided by the sum of the masses ABi. The following formula therefore results:

$$x 0 = \frac{Σ ( ABi * xi )}{Σ ABi}$$

where the summation is respectively performed via the index i, e.g., in the case of three modules with i=1, 2, 3, whereby the following results:

$$x 0 = \frac{AB 1 * x 1 + AB 2 * x 2 + AB 3 * x 3}{AB 1 + AB 2 + AB 3}$$

According to an embodiment shown in FIG. 1, the center of gravity S is calculated in that the reference point (observation point) is placed on the front axle A1. With known axle loads F1, F2, and F3 on the axles A1, A2, A3 and the corresponding wheel bases R1 and R2, the center of gravity S of the vehicle 1 may be determined. Since, in the model shown in FIG. 1, the following variables L1 and L2 are not known, some of the variables are replaced by known variables:

$${L}_{1} = \frac{{F}_{1} * 0 + {F}_{2} * {R}_{1} + {F}_{3} * ( {R}_{1} + {R}_{2} )}{{F}_{1} + {F}_{2} + {F}_{3}}$$

$$with$$

$${L}_{2} = {R}_{1} - {L}_{1}$$

$${R}_{1} - {L}_{2} = \frac{{F}_{1} * 0 + {F}_{2} * {R}_{1} + {F}_{3} * ( {R}_{1} + {R}_{2} )}{{F}_{1} + {F}_{2} + {F}_{3}}$$

$${L}_{2} = {R}_{1} - \frac{{F}_{1} * 0 + {F}_{2} * {R}_{1} + {F}_{3} * ( {R}_{1} + {R}_{2} )}{{F}_{1} + {F}_{2} + {F}_{3}}$$

$${L}_{2} = {R}_{1} - \frac{{F}_{2} * {R}_{1} + {F}_{3} * ( {R}_{1} + {R}_{2} )}{{F}_{1} + {F}_{2} + {F}_{3}}$$

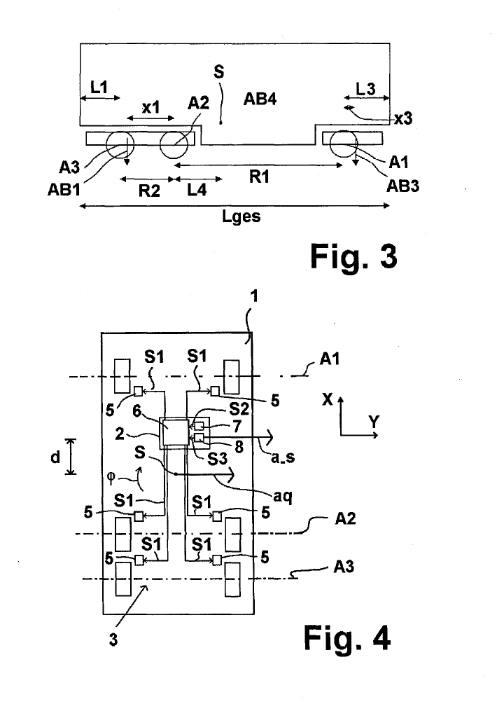

According to an embodiment shown in FIG. 3, the center of gravity S is calculated in that modules are formed to represent the mass distribution of the vehicle 1, i.e., in particular of a loaded utility vehicle 1. The following formula thus results as the concrete sum of a few modules, in particular, e.g., three modules having masses AB1, AB4, AB3. The center of gravity of this entire formation can thus be formed using relatively simple formulas and few parameters. In the case of a loaded utility vehicle 1, respective specifically defined modules may be represented and determined. In a vehicle having two axles or having three axles, if the two rear axles are close to one another as rear axles, in particular a front region, a middle region, and a rear region can be applied.

According to the embodiment described with reference to FIG. 3, the vehicle center of gravity can also be determined from the module weights, which are used in the above formula of the torque equilibrium. In this case, the following characteristic variables of a module can be used:
the weights of the modules, i.e., AB1 and AB3, are known,
the distance of the center of gravity of the module AB1 or AB3, respectively, to the relevant axles is known as the values x1 and x3,
mean overhangs of the modules AB1 and AB3 are known as L1 and L3.

The vehicle length Lges may be determined from this data and from the wheel base known per se, i.e., R1 and R2. Under the assumption that the structure is homogeneously distributed, the vehicle center of gravity S and the weight of the structure can be calculated. The reference point for the determination of the center of gravity of the entire vehicle can be fixed in this case on the vehicle rear. This is schematically shown in FIG. 3.

Since the structure of the individual vehicles 1 can differ in height, it is reasonable to keep the mass distribution of the middle module AB4 variable. In this case, the following values for AB4 can be applied for the following vehicle types:

low-floor bus 450 kg/m,

high-decker bus 500 kg/m,

double-decker bus 650 kg/m.

This constant is used as GB in the following system of equations:

$${L}_{1} + {R}_{2} + {L}_{4} = \frac{\begin{matrix}{AB}_{1} * ( {L}_{1} + {R}_{2} - {x}_{1} ) + \\ {AB}_{3} * ( {L}_{1} + {R}_{2} + {R}_{1} + {x}_{3} )\end{matrix} + {AB}_{4} * \frac{{L}_{1} + {R}_{2} + {R}_{1} + {L}_{3}}{2}}{{AB}_{1} + {AB}_{3} + {AB}_{4}}$$

$${L}_{4} = \frac{\begin{matrix}{AB}_{1} * ( {L}_{1} + {R}_{2} - {x}_{1} ) + \\ {AB}_{3} * ( {L}_{1} + {R}_{2} + {R}_{1} + {x}_{3} )\end{matrix} + {AB}_{4} * \frac{{L}_{1} + {R}_{2} + {R}_{1} + {L}_{3}}{2}}{{AB}_{1} + {AB}_{3} + {AB}_{4}} - {L}_{1} - {R}_{2}$$

The center of gravity S can therefore be determined accordingly.

In this case, supplementary data about the size and position of the luggage compartment, also the size and position of the diesel tank, and the size and position of the battery can also be incorporated, which are initially used in generalized form in the above applied modules.

According to another embodiment, the vehicle center of gravity S can also be determined by external systems or their data signals, wherein, e.g., values for the wheel loads F1, F2, and F3 can be used by a level control system, in particular an electronically regulated ECAS of the vehicle 1. With incorporation of the known wheel bases R1 and R2, the center of gravity S of the vehicle may be determined in FIG. 1. If L1 and L2 are not known, the following formula can be used:

$${L}_{1} = \frac{{F}_{1} * 0 + {F}_{2} * {R}_{1} + {F}_{3} * ( {R}_{1} + {R}_{2} )}{{F}_{1} + {F}_{2} + {F}_{3}}$$

$$with$$

$${L}_{2} = {R}_{1} - {L}_{1}$$

$${R}_{1} - {L}_{2} = \frac{{F}_{1} * 0 + {F}_{2} * {R}_{1} + {F}_{3} * ( {R}_{1} + {R}_{2} )}{{F}_{1} + {F}_{2} + {F}_{3}}$$

$${L}_{2} = {R}_{1} - \frac{{F}_{1} * 0 + {F}_{2} * {R}_{1} + {F}_{3} * ( {R}_{1} + {R}_{2} )}{{F}_{1} + {F}_{2} + {F}_{3}}$$

$${L}_{2} = {R}_{1} - \frac{{F}_{2} * {R}_{1} + {F}_{3} * ( {R}_{1} + {R}_{2} )}{{F}_{1} + {F}_{2} + {F}_{3}}$$

A compensation to determine the center of gravity lateral acceleration aq can therefore subsequently be performed.

In the embodiments discussed above, the compensation in the X direction was determined first. A corresponding compensation or correction can accordingly also be performed in the Z direction, i.e., the vertical axis, wherein the roll angle change is used instead of the yaw rate change φ′. If a triangle quadrant yaw rate sensor is used as the yaw rate sensor 7, which therefore also detects this dynamic change variable of the roll angle, the installation location is therefore absolutely variable.

It will thus be seen that the objects set forth above, among those made apparent from the preceding description, are efficiently attained, and since certain changes may be made in the above processes and constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention that, as a matter of language, might be said to fall therebetween.

What is claimed is:

1. A control module for a vehicle system, the control module comprising:
a lateral acceleration sensor to measure a lateral acceleration of the vehicle and output a lateral acceleration measuring signal;
a yaw rate sensor to detect a yaw rate of the vehicle and output a yaw rate measuring signal; and
a central control unit configured to record the yaw rate measuring signal and the lateral acceleration measuring signal, filter the yaw rate measuring signal using a low-pass filter, form a time derivative, substantially instantaneously determine a sensor distance of the lateral acceleration sensor from the center of gravity of the vehicle, and determine a center of gravity lateral acceleration of the vehicle in the center of gravity of the vehicle based at least in part on the
sensor distance and the filtered yaw rate measuring signal.

2. The control module as claimed in claim 1, wherein the low-pass filter is a Tschebyscheff filter.

3. The control module as claimed in claim 1, wherein the central control unit is configured to determine the sensor distance from a torque equilibrium of the center of gravity of the vehicle.

4. The control module as claimed in claim 3, wherein the central control unit is configured to determine at least one of wheel loads and axle loads of the vehicle, and the center of gravity of the vehicle based at least in part on the at least one of the wheel loads and axle loads and on wheel bases of the vehicle.

5. The control module as claimed in claim 1, wherein the central control unit is configured to determine the center of gravity of the vehicle based at least in part on weights of vehicle modules.

6. The control module as claimed in claim 5, wherein the central control unit is configured to determine the center of gravity of the vehicle based at least in part on distances of the centers of gravity of the modules to vehicle axles and mean overhangs of a front and rear module.

7. The control module as claimed in claim 1, wherein the central control unit is configured to receive at least some vehicle data for determining the center of gravity of the vehicle from at least one source of the vehicle data external to the central control unit.

8. A vehicle dynamics control system, comprising a control module as claimed in claim 1.

9. A vehicle, comprising a vehicle dynamics control system as claimed in claim 8.

10. A method for controlling a vehicle, comprising:
measuring a yaw rate and forming a yaw rate measuring signal;
measuring a vehicle lateral acceleration outside of a center of gravity of the vehicle and forming a lateral acceleration measuring signal;
filtering the yaw rate measuring signal using a low-pass filter, and forming a time derivative of the filtered yaw rate measuring signal;
determining a sensor distance between the lateral acceleration sensor and the center of gravity of the vehicle substantially instantaneously; and
determining a center of gravity lateral acceleration based at least in part on the lateral acceleration measuring signal, the sensor distance and the filtered yaw rate measuring signal.

11. The method as claimed in claim 10, wherein the low-pass filter is a Tschebyscheff filter.

12. The method as claimed in claim 10, wherein determining the sensor distance includes determining the center of gravity of the vehicle and the distance of the center of gravity of the vehicle to a lateral acceleration sensor, and wherein determining the center of gravity from includes determining a torque equilibrium of the vehicle based at least in part on wheel bases of the vehicle and at least one of wheel loads and axle loads of the vehicle.

13. The method as claimed in claim 12, wherein the vehicle includes multiple modules, and wherein determining the center of gravity of the vehicle is based at least in part on at least one of weights and masses of the modules.

14. The control module as claimed in claim 1, wherein the low-pass filter has a limiting frequency of about 7 to 10 Hz.

15. The control module as claimed in claim 1, wherein the low-pass filter has a limiting frequency of about 7.5 to 8.5 Hz.

16. The vehicle as claimed in claim 9, wherein the vehicle is a bus.

17. The method as claimed in claim 10, wherein the low-pass filter has a limiting frequency of about 7 to 10 Hz.

18. The method as claimed in claim 10, wherein the low-pass filter has a limiting frequency of about 7.5 to 8.5 Hz.
